(19) United States
(12) Patent Application Publication
(10) Pub. No.: US 2026/0277960 A1
(43) Pub. Date: Sep. 17, 2026

(54) INFORMATION PROCESSING METHOD, COMPUTER PROGRAM, AND INFORMATION PROCESSING APPARATUS

(71) Applicant: Tokyo Electron Limited, Tokyo (JP)

(72) Inventors: Kenji MATOGAWA, Sapporo City (JP); Atsushi SUZUKI, Sapporo City (JP)

(73) Assignee: Tokyo Electron Limited, Tokyo (JP)

(21) Appl. No.: 19/679,773

(22) Filed: May 18, 2026

Related U.S. Application Data
(63) Continuation of application No. PCT/JP2024/041279, filed on Nov. 21, 2024.

(30) Foreign Application Priority Data
Nov. 27, 2023 (JP) 2023-200129

(51) Int. Cl. G06F 16/3329; G06F 16/34

(52) U.S. Cl. CPC G06F 16/33295; G06F 16/345

(57) ABSTRACT

An information processing method includes: inputting, into a language generation model, a request for generating related data including a question sentence with respect to target data relating to a specific apparatus or system, a summary of the target data, or a question sentence with respect to the summary, and acquiring the related data output by the language generation model, storing, in a database, the target data and the related data in association with each other, acquiring a question relating to the apparatus or the system, retrieving the related data from the database based on the question, extracting the target data associated with the retrieved related data from the database, inputting the question and the extracted target data into the language generation model, and acquiring an answer to the question output by the language generation model, and outputting the acquired answer.

### CROSS-REFERENCE TO RELATED APPLICATIONS

This application is a bypass continuation application of international application No. PCT/JP2024/041279 having an international filing date of Nov. 21, 2024 and designating the United States, the international application being based upon and claiming the benefit of priority from Japanese Patent Application No. 2023-200129, filed on Nov. 27, 2023, the entire contents of each are incorporated herein by reference.

### TECHNICAL FIELD

The present disclosure relates to an information processing method, a computer program, and an information processing apparatus.

### BACKGROUND

When performing any work such as an operation or maintenance with respect to any apparatus such as a machine tool, it may be desired to refer to information relating to the apparatus. For example, when cleaning for the apparatus is performed, it is desired to refer to information describing a procedure of the cleaning. With respect to a system that includes a plurality of apparatuses, it may be desired to refer to information relating to the system. PTL 1 discloses a technique of displaying useful information for a work with respect to a substrate processing apparatus that performs processing such as etching or film formation on a substrate such as a semiconductor wafer or a glass substrate.

### CITATION LIST

### Patent Documents

PTL 1: JP2014-164482A.

### SUMMARY

The information relating to the apparatus or the system is included in data that includes a large amount of information such as a manual. A user can retrieve desired information from the data and use the retrieved information. However, in a retrieval method in the related art using a keyword or the like, it may be difficult for the user to find desired information.

The disclosure provides an information processing method, a computer program, and an information processing apparatus for obtaining information desired by a user.

An information processing method according to an aspect of the disclosure includes: inputting, into a language generation model, a request for generating related data including a question sentence with respect to target data relating to a specific apparatus or system, a summary of the target data, or a question sentence with respect to the summary, and acquiring the related data output by the language generation model, storing, in a database, the target data and the related data in association with each other, acquiring a question relating to the apparatus or the system, retrieving the related data from the database based on the question, extracting the target data associated with the retrieved related data from the database, inputting the question and the extracted target data into the language generation model, and acquiring an answer to the question output by the language generation model, and outputting the acquired answer.

According to the disclosure, an information processing method, a non-transitory computer-readable storage medium, and an information processing apparatus for obtaining information desired by a user can be provided.

### BRIEF DESCRIPTION OF DRAWINGS

FIG. 1 is a conceptual diagram illustrating an outline of an information processing method according to an embodiment.

FIG. 2 is a block diagram illustrating an example of an internal configuration of an information processing apparatus.

FIG. 3 is a flowchart illustrating an example of a procedure of processing of storing, in a database, target data and related data, which is executed by the information processing apparatus.

FIG. 4 is a schematic diagram illustrating examples of original data and the target data.

FIG. 5 is a table illustrating another example of the target data.

FIG. 6 is a schematic diagram illustrating an example of a content stored in the database.

FIG. 7 is a flowchart illustrating an example of a procedure of processing of outputting an answer to a question from a user, which is executed by the information processing apparatus.

FIG. 8 is a schematic diagram illustrating an example of the output answer.

### DETAILED DESCRIPTION

Hereinafter, the disclosure will be specifically described with reference to the drawings illustrating an embodiment thereof.

With respect to a specific apparatus or system, various types of information may be referred to. For example, the apparatus is a substrate processing apparatus that performs processing such as etching or film formation on a substrate such as a semiconductor wafer or a glass substrate. For example, the system is a system including various devices used in relation to the substrate processing apparatus. The system may include a device that manages the substrate processing apparatus such as an apparatus that stores a recipe defining a content of a process performed by the substrate processing apparatus or performs input and output with respect to the substrate processing apparatus, and an apparatus that acquires and accumulates log data recording an operation content of the substrate processing apparatus. The system may also include a group controller that manages a plurality of substrate processing apparatuses. For example, when performing a work on a substrate processing apparatus or a system such as an operation or maintenance for the substrate processing apparatus or the system, a user may refer to information relating to the operation or the work, such as an operation method, a work procedure, or a caution. Since data such as a manual relating to the substrate processing apparatus or the system includes a large amount of information, a retrieval method in the related art such as the use of keywords may not acquire information desired by the user. For example, when information relating to cleaning for a piping of the substrate processing apparatus is required, information relating to cleaning for the portion other than the piping may be retrieved. In the embodiment, an information processing method for obtaining the information desired by the user is performed.

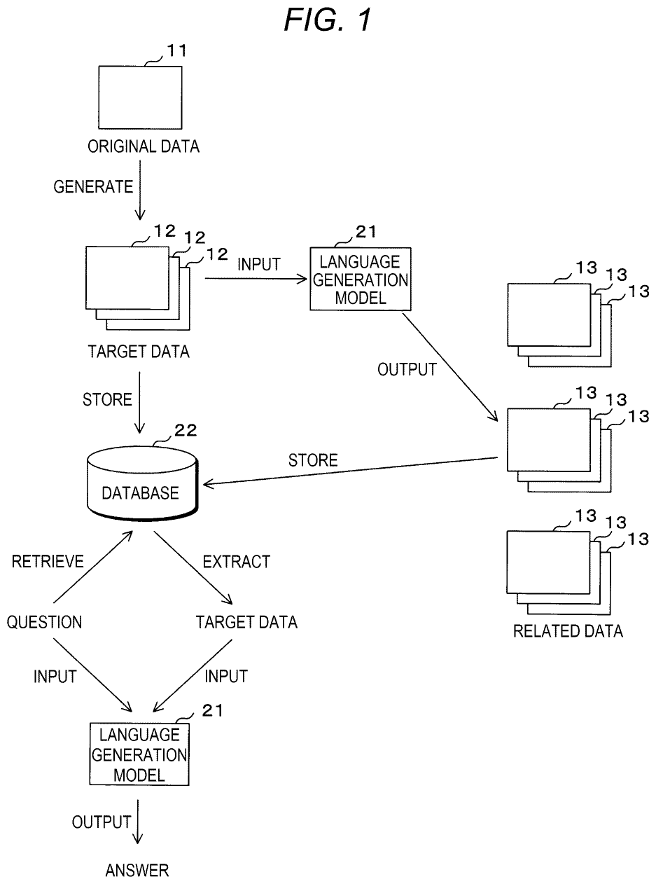

FIG. 1 is a conceptual diagram illustrating an outline of the information processing method according to the embodiment. There is original data 11 for the specific apparatus or system. For example, the original data 11 is a manual of the apparatus or the system, log data recording the operation content, alarm information recording a history of an alarm, a record of a problem countermeasure, a record of maintenance, or the like. The record of the problem countermeasure includes a record of a work performed in response to the alarm, and may include, for example, a content of the work to restore the apparatus or the system in response to the occurrence of the alarm, such as reception of the alarm, replacement of parts, reassembly of parts, cleaning for parts, or calibration for a sensor. A plurality of pieces of target data 12 are generated from the original data 11. The target data 12 is data that is a reference target from the user. The target data 12 is generated by dividing the original data 11 or extracting a part of the original data 11. The target data 12 may be generated by combining a plurality of elements extracted from the original data 11.

The target data 12 is input into a language generation model 21, and related data 13 relating to the target data 12 is output from the language generation model 21. The related data 13 includes a question sentence with respect to the target data 12, a summary of the target data 12, or a question sentence with respect to the summary. A plurality of pieces of related data 13 are generated for one piece of target data 12 by using the language generation model 21. The target data 12 and the related data 13 relating to the target data 12 are stored in a database 22 in association with each other.

In a state where the target data 12 and the related data 13 are stored in the database 22, a question from the user with respect to the substrate processing apparatus or the system is acquired. The related data 13 is retrieved from the database 22 based on the question, and the target data 12 associated with the retrieved related data 13 is extracted from the database 22. The question and the extracted target data 12 are input into the language generation model 21, and an answer to the question is output from the language generation model 21. The answer corresponds to information relating to the substrate processing apparatus or the system. For example, the answer may be information relating to the operation of the substrate processing apparatus or the system, or information relating to the work performed on the substrate processing apparatus or the system.

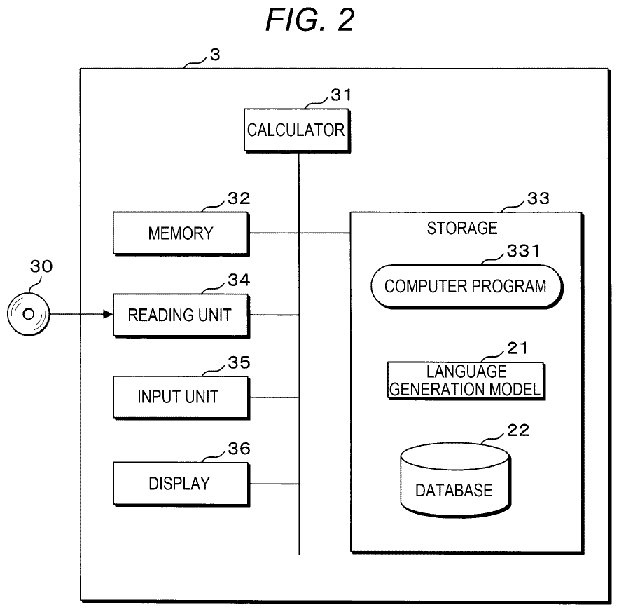

The information processing method is executed by the information processing apparatus. FIG. 2 is a block diagram illustrating an example of an internal configuration of an information processing apparatus 3. The information processing apparatus 3 executes an information processing method. The information processing apparatus 3 is implemented using a computer such as a personal computer or a server device. The information processing apparatus 3 includes a calculator 31 (e.g., calculator circuitry), a memory 32, a storage 33, a reading unit 34, an input unit 35, and a display 36. The calculator 31 is, for example, a processor, and is implemented using a central processing unit (CPU), a graphics processing unit (GPU), or a multi-core CPU. The calculator 31 may also be implemented using a quantum computer. The memory 32 stores temporary data generated along with a calculation. The memory 32 is, for example, a random access memory (RAM). The storage 33 is non-volatile, and is, for example, a hard disk or a non-volatile semiconductor memory. The reading unit 34 reads information from a recording medium 30 such as an optical disk or a portable memory. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium, such as a CD-ROM or DVD, and/or the memory of a FPGA or ASIC.

The input unit 35 receives an input of data. The input unit 35 includes an operation unit that receives an input of information such as text by receiving an operation from a user. The operation unit is, for example, a touch panel, a keyboard, or a pointing device. The input unit 35 may include an input interface into which various pieces of data are received from the outside of the information processing apparatus 3. The display 36 displays an image. The display 36 is, for example, a liquid crystal display or an electroluminescent display (EL display).

The calculator 31 causes the reading unit 34 to read a computer program 331 recorded in the recording medium 30, and causes the storage 33 to store the read computer program 331. The calculator 31 executes processing for implementing functions of the information processing apparatus 3 according to the computer program 331. The computer program 331 may be a program product. The computer program 331 may be stored in advance in the storage 33 or may be downloaded from outside the information processing apparatus 3. In this case, the information processing apparatus 3 does not need to be provided with the reading unit 34.

The computer program 331 may be loaded to be executed on a single computer or on a plurality of computers disposed at one site or distributed across a plurality of sites and interconnected by a communication network. That is, the information processing apparatus 3 may be implemented by a plurality of computers, and the computer program 331 may be executed on the plurality of computers connected via the communication network. The information processing apparatus 3 may be implemented using a cloud server.

Processing of each step to be described later for executing the information processing method can be executed by a plurality of computers. The processing of each step may be executed by different computers. The processing of each step can also be executed using a virtual machine. The processing of each step may be executed by a plurality of calculators. The processing of each step may be executed by different calculators.

The information processing apparatus 3 includes the language generation model 21. When a prompt including a command sentence requesting a certain answer and information attached to the prompt are input, the language generation model 21 is a trained model that is trained to output sentences corresponding to the input prompt and information. For example, the language generation model 21 is a large language model. More specifically, the language generation model 21 is, for example, BERT, GPT-4, Bard, or LLaMA. The language generation model 21 has been trained in advance.

The language generation model 21 is implemented by executing information processing by the calculator 31 according to the computer program 331. The storage 33 stores data for implementing the language generation model 21. The language generation model 21 may be implemented by hardware. The language generation model 21 may be implemented by using a quantum computer. Alternatively, the language generation model 21 may be provided outside the information processing apparatus 3, and the information processing apparatus 3 may execute processing using the external language generation model 21. The language generation model 21 may be implemented by using a plurality of computers connected via a communication network, or may be implemented by using a cloud.

The information processing apparatus 3 includes the database 22. As described above, the database 22 stores the target data 12 and the related data 13. The database 22 is implemented by the storage 33 storing necessary data. The database 22 may be implemented by using hardware other than the storage 33. The database 22 may be implemented by using a plurality of computers. For example, the data stored in the database 22 may be distributed and stored in the plurality of computers. Alternatively, the database 22 may be provided outside the information processing apparatus 3, and the information processing apparatus 3 may execute processing using the external database 22.

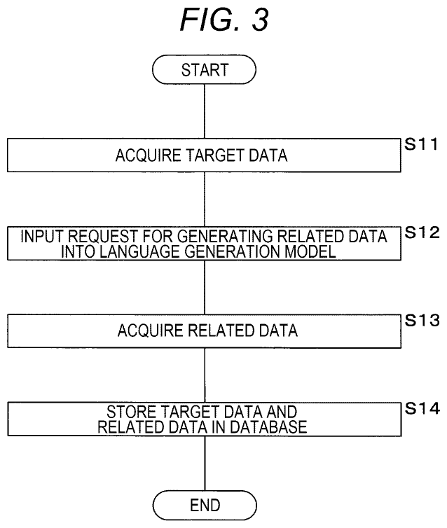

The information processing apparatus 3 performs processing of storing the target data 12 and the related data 13 in the database 22. FIG. 3 is a flowchart illustrating an example of a procedure of processing of storing, in the database 22, the target data 12 and the related data 13, which is executed by the information processing apparatus 3. Hereinafter, step will be abbreviated as S. The information processing apparatus 3 performs the following processing by the calculator 31 performing the information processing according to the computer program 331.

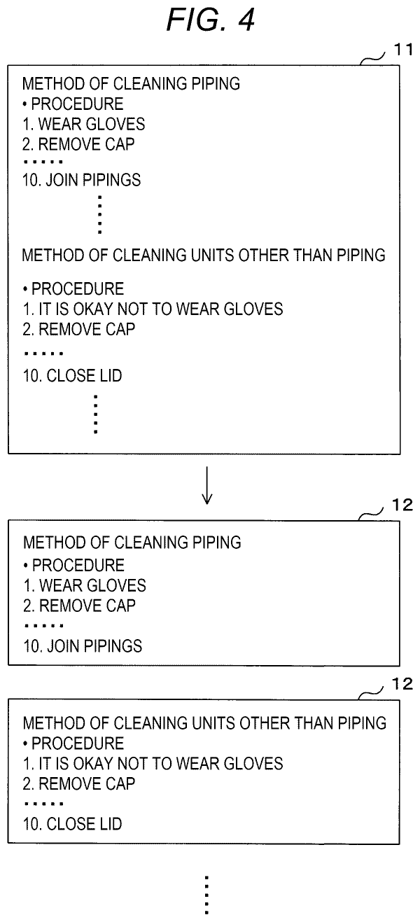

The information processing apparatus 3 acquires the target data 12 (S11). The original data 11 is input to the information processing apparatus 3 through the input unit 35, stored in the storage 33, or the original data 11 is stored in advance in the storage 33, and the plurality of pieces of target data 12 are generated from the original data 11. FIG. 4 is a schematic diagram illustrating examples of the original data 11 and the target data 12. In the example illustrated in FIG. 4, the original data 11 is the manual of the substrate processing apparatus, and includes sentences relating to a method of cleaning a piping and a method of cleaning units other than the piping. The original data 11 is divided into the plurality of pieces of target data 12. In the example illustrated in FIG. 4, the target data 12 that includes only the sentences relating to the method of cleaning the piping and the target data 12 that includes only the sentences relating to the method of cleaning units other than the piping are generated from the original data 11.

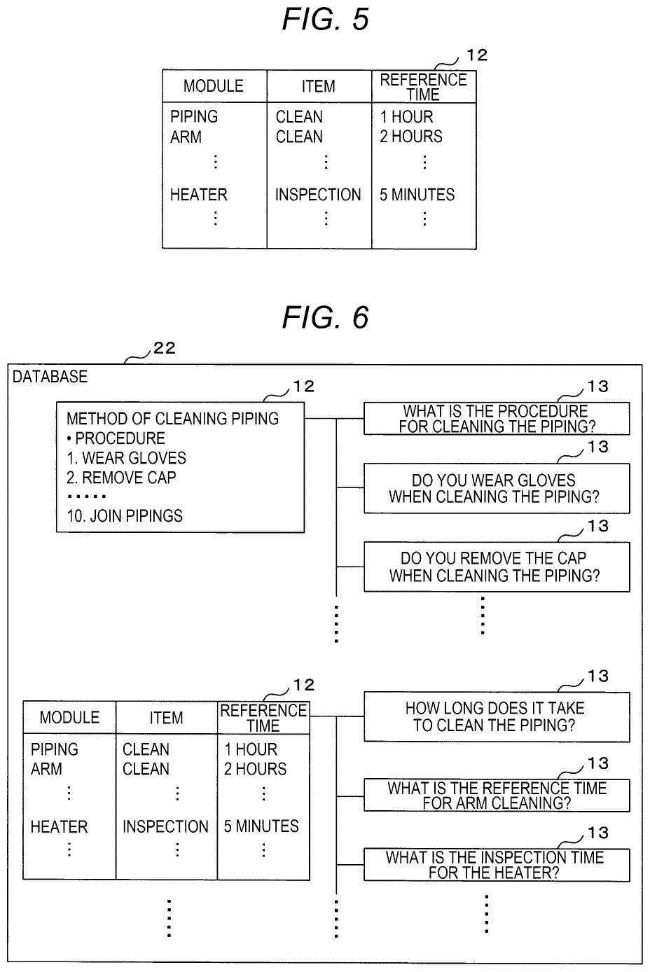

FIG. 5 is a table illustrating another example of the target data 12. The target data 12 illustrated in FIG. 5 is data in a tabular format. For each module such as a piping of the substrate processing apparatus, a work item such as cleaning and a reference time, which is a reference value of a work time, are recorded. Accordingly, the target data 12 composed of sentences or the target data 12 in a tabular format are generated from the original data 11. The target data 12 in a graph format may be generated.

For example, the calculator 31 divides the original data 11 into chapters, items, pages, or paragraphs, thereby generating the target data 12 composed of sentences. For example, the calculator 31 extracts a table included in the original data 11 to generate the target data 12 in a tabular format. The calculator 31 may display the contents of the original data 11 on the display 36, and generate the target data 12 according to an instruction received from the user who has confirmed the contents of the original data 11. For example, the calculator 31 receives, by the user operating the operation unit provided in the input unit 35, the instruction to designate a position where the original data 11 is divided or a part to be extracted from the original data 11. The calculator 31 generates the target data 12 by dividing the original data 11 or extracting a part of the original data 11 according to the received instruction. The calculator 31 may receive a designation of a plurality of contents to be extracted from the original data 11, extract the plurality of designated contents from the original data 11, and generate the target data 12 composed of sentences or the target data 12 in a tabular format by combining the plurality of extracted contents. Accordingly, a plurality of pieces of target data 12 each including only a part of the information included in the original data 11 are generated.

The information processing apparatus 3 may input, via the input unit 35, the plurality of pieces of target data 12 that have been generated. The calculator 31 stores, in the storage 33, the plurality of pieces of generated target data 12 or the plurality of pieces of received target data 12. In S11, the calculator 31 acquires the target data 12 by reading the target data 12 from the storage 33.

The information processing apparatus 3 inputs a request for generating the related data 13 relating to the target data 12 into the language generation model 21 (S12). The related data 13 is a question sentence with respect to the target data 12, a summary of the target data 12, or a question sentence with respect to the summary. In S12, the calculator 31 generates a prompt including the target data 12 and a request for generating the related data 13, and inputs the generated prompt to the language generation model 21.

An example of the prompt received from the calculator 31 to the language generation model 21 in S12 will be described below.

“Please generate a question sentence that can be answered only based on the following target data. {target data}”.

“Please generate a summary of the following target data using 1/10 or less of the original sentence. {target data}”.

“Please generate a summary of the following target data using 1/10 or less of the original sentence, and generate a question sentence that can be answered only based on the generated summary. {target data}”.

The position of {target data} included in the example of the prompt includes the target data 12. The calculator 31 may input, instead of the target data 12, a prompt including information for referencing the target data 12, such as an address where the target data 12 is stored, into the language generation model 21.

In order to generate the question sentence for the summary of the target data 12 as the related data 13, the calculator 31 may use, instead of the target data 12, a prompt that includes the summary of the target data 12 generated using the language generation model 21. Examples of the prompt are illustrated below.

“Please generate a question sentence that can be answered only based on the following summary. {summary}”.

The position of {summary} included in the example of the prompt includes the summary of the target data 12 generated using the language generation model 21. The prompt may include, instead of the summary, information for referencing the summary. When the target data 12 is data in a tabular format, the calculator 31 may generate text data representing the contents of the target data 12 in a tabular format, such as data obtained by writing the contents of the target data 12 in a tabular format in text, a description describing the contents of the target data 12, or data obtained by converting the target data 12 into a markdown format, and include the text data in the prompt.

The language generation model 21 performs a calculation according to an input of the prompt, and outputs a sentence. The prompt input to the language generation model 21 includes a request to generate the related data 13 relating to the target data 12, and thus the language generation model 21 outputs the related data 13 responsive to the target data 12. The related data 13 to be output is a question sentence with respect to the target data 12, a summary of the target data 12, or a question sentence with respect to the summary.

The information processing apparatus 3 acquires the related data 13 relating to the target data 12 (S13). In S13, the calculator 31 acquires the related data 13 output from the language generation model 21. The calculator 31 repeats the processing of S12 and S13 with respect to one piece of the target data 12, thereby acquiring the plurality of pieces of related data 13 relating to the one piece of target data 12. For example, the calculator 31 causes the language generation model 21 to generate the plurality of pieces of related data 13 by using a plurality of types of prompts described above. Further, the calculator 31 repeats the processing of S12 and S13 with respect to each of the plurality of pieces of target data 12, thereby acquiring the plurality of pieces of related data 13 relating to each of the plurality of pieces of target data 12. The calculator 31 may select, as the related data 13 to be acquired, the type of the question sentence with respect to the target data 12, the summary of the target data 12, and the question sentence with respect to the summary. For example, the calculator 31 may select the type or combination of a plurality of types of the related data 13 to be acquired, or may acquire all types of the related data 13, according to the instruction from the user.

The information processing apparatus 3 stores the target data 12 and the related data 13 in the database 22 (S14). In S14, the calculator 31 causes the database 22 to store the target data 12 and the related data 13 relating to the target data 12 in association with each other. At this time, the calculator 31 associates the plurality of pieces of related data 13 acquired for one piece of target data 12 with the one piece of target data 12.

FIG. 6 is a schematic diagram illustrating an example of a content stored in the database 22. In the database 22, the plurality of pieces of target data 12 are stored, and the plurality of pieces of related data 13 are associated with the respective pieces of target data 12. For example, the target data 12 that includes information on the method of cleaning the piping is associated with the plurality of pieces of related data 13 that are questions with respect to the target data 12, such as “What is the method of cleaning the piping?” or “Do you wear gloves when cleaning the piping?”. The target data 12 may be associated with a summary of the target data 12 or a question sentence for the summary, as the related data 13.

In S14, the calculator 31 vectorizes, for example, the target data 12 and the related data 13, and causes the database 22 to store the target data 12 and the related data 13. The calculator 31 may select, as the related data 13 to be stored in the database 22, the type of the question sentence with respect to the target data 12, the summary of the target data 12, and the question sentence with respect to the summary. For example, the calculator 31 may select the type or combination of the plurality of types of related data 13 to be stored in the database 22, or may cause the database 22 to store all types of the related data 13, according to the instruction from the user. After S14 ends, the information processing apparatus 3 ends the processing of storing the target data 12 and the related data 13 in the database 22. The processing of S11 to S14 is executed as necessary.

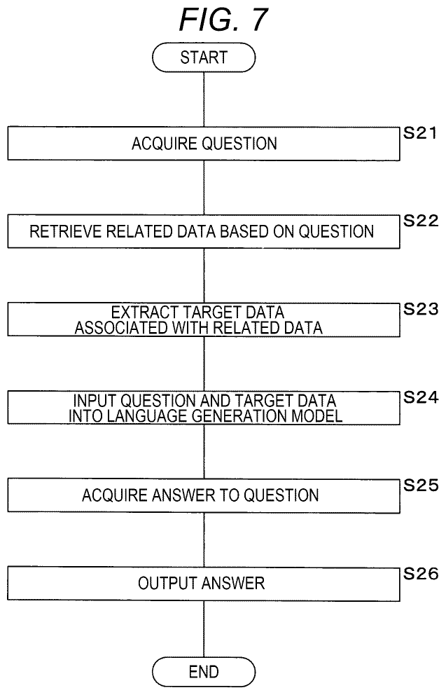

In a state where the target data 12 and the related data 13 are stored in the database 22, the information processing apparatus 3 performs processing of outputting an answer to a question from the user, based on the database 22. FIG. 7 is a flowchart illustrating an example of a procedure of the processing of outputting the answer to the question from the user, which is executed by the information processing apparatus 3. The information processing apparatus 3 performs the following processing by the calculator 31 performing the information processing according to the computer program 331.

The information processing apparatus 3 acquires a question from the user (S21). In S21, the user operates the operation unit provided in the input unit 35 to input the question from the user into the information processing apparatus 3, and the calculator 31 acquires the input question. The question may be input by voice input. The question from the user is a question with respect to the substrate processing apparatus or the system. That is, the question from the user is a question relating to the information included in the original data 11. The calculator 31 stores the acquired question in the storage 33.

The information processing apparatus 3 retrieves the related data 13 from the database 22 based on the acquired question (S22). In S22, the calculator 31 retrieves the related data 13 having a high similarity (e.g., a similarity above a threshold value) to the acquired question from the plurality of pieces of related data 13 stored in the database 22. For example, the calculator 31 vectorizes the acquired question, calculates a similarity between the vectorized question and the plurality of pieces of vectorized related data 13, and retrieves the related data 13 having the largest similarity. By retrieving the related data 13 instead of the target data 12 directly, the system utilizes the more concise and relevant context of the generated question sentences to improve retrieval accuracy. For example, the calculator 31 calculates, as the similarity, a cosine similarity or a similarity based on the Euclidean distance. By using the similarity, the related data 13 similar to the acquired question can be retrieved. The calculator 31 may retrieve the related data 13 by using a method other than the method of calculating the similarity, such as performing a morphological analysis to retrieve the related data 13 having a meaning closest to the question.

The calculator 31 may select, as the related data 13 to be retrieved, the type of the question sentence with respect to the target data 12, the summary of the target data 12, and the question sentence with respect to the summary. For example, the calculator 31 may select the type or combination of a plurality of types of the related data 13 to be retrieved, or may retrieve all types of the related data 13, according to the instruction from the user.

The information processing apparatus 3 extracts the target data 12 associated with the retrieved related data 13 from the database 22 (S23). In S23, the calculator 31 extracts the target data 12 stored in the database 22 in association with the related data 13 obtained by the retrieval. That is, the target data 12 is extracted according to the question. For example, a question “Is it okay not to wear gloves when cleaning the piping?” is acquired in S21, and in S22, the related data 13 “Do you wear gloves when cleaning the piping?” included in the example illustrated in FIG. 6 is retrieved. In S23, the target data 12 including information on the method of cleaning the piping, which is included in the example illustrated in FIG. 6, is extracted.

In S22 and S23, the calculator 31 may retrieve the target data 12 from the database 22 based on the question, and may extract the retrieved target data 12 from the database 22. For example, the calculator 31 retrieves the target data 12 having a high similarity to the question from the database 22. Even when this processing is performed, the information processing apparatus 3 can acquire appropriate target data 12 as the basis for an answer to the question from the user.

The information processing apparatus 3 inputs the question from the user and the extracted target data 12 into the language generation model 21 (S24). In S24, the calculator 31 generates a prompt including a request to answer a question based on the extracted target data 12, and inputs the generated prompt into the language generation model 21.

An example of the prompt received from the calculator 31 to the language generation model 21 in S24 will be described below.

“Please answer the following questions based on the following target data. {question} {target data}”.

The position of the {question} included in the example of the prompt includes the question acquired in S21, and the position of the {target data} includes the target data 12 extracted in S23. The calculator 31 may input, instead of the target data 12, a prompt including information for referencing the target data 12, such as an address in the database 22 where the target data 12 is stored, into the language generation model 21.

The language generation model 21 performs a calculation according to an input of the prompt, and outputs an answer to the question. Since the prompt input to the language generation model 21 includes a request to answer a question based on the target data 12, the language generation model 21 outputs an answer based on the target data 12. For example, in response to the question “Is it okay not to wear gloves when cleaning the piping?”, the answer “You need to wear gloves” is output based on the target data 12 that includes the information on the method of cleaning the piping, which is included in the example illustrated in FIG. 6.

The information processing apparatus 3 acquires an answer to the question from the user (S25). In S25, the calculator 31 acquires the answer output from the language generation model 21. The calculator 31 stores the acquired answers in the storage 33. The information processing apparatus 3 outputs the acquired answer (S26). In S26, the calculator 31 causes the display 36 to display an image that includes the acquired answer, thereby outputting the answer.

The calculator 31 may cause the display 36 to display an image that also includes the related data 13 retrieved in S22, thereby outputting the related data 13 retrieved in S22, in addition to the answer. By outputting the retrieved related data 13, the user can determine whether the retrieved related data 13 is data far apart from the question. When the retrieved related data 13 is data far apart from the question, the possibility that the answer to the question is incorrect becomes high.

The calculator 31 may cause the display 36 to display an image that also includes the target data 12 extracted in S23, thereby outputting the target data 12 extracted in S23, in addition to the answer. By outputting the extracted target data 12, the user can confirm the information that served as the basis for the answer. The calculator 31 may output information for referencing the target data 12 extracted in S23, such as a link to the target data 12 stored in the database 22. Even in this case, the user can confirm the information that served as the basis for the answer.

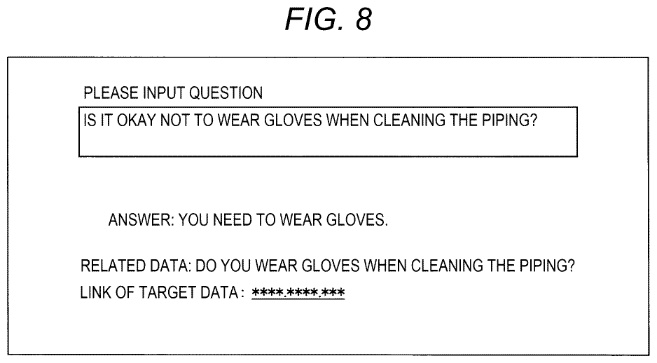

FIG. 8 is a schematic diagram illustrating an example of the output answer. FIG. 8 illustrates an example of an image including the answer displayed on the display 36. The image includes a field for inputting a question, and a question “Is it okay not to wear gloves when cleaning the piping?” is input. The image includes the answer “You need to wear gloves” according to the question, and further includes the contents of the retrieved related data 13 and the link for referencing the extracted target data 12. Accordingly, the answer, the retrieved related data 13, and the link of the extracted target data 12 are output. The user can confirm a desired answer according to the question by visually recognizing the image displayed on the display 36. Further, the user can confirm the contents of the retrieved related data 13, and can also confirm the contents of the target data 12 by using the link of the target data 12.

The calculator 31 may output, in addition to the answer, the original data 11 that is the source of the target data 12 extracted in S23. For example, the storage 33 stores the original data 11, and the calculator 31 causes the display 36 to display an image including the original data 11 that is the source of the target data 12. A part of the original data 11 that serves as the basis for the target data 12 may be output. For example, a page corresponding to the content of the target data 12 may be displayed in the original data 11 that is a manual, or the original data 11 may be displayed in a state where a part corresponding to the content of the target data 12 is highlighted. The calculator 31 may output information for referencing the original data 11 such as a link to the original data 11 stored in the storage 33. In these forms, the user can confirm the source of the information on which the answer is based.

After S26 ends, the information processing apparatus 3 ends the processing of outputting an answer to the question from the user. The processing of S21 to S26 is executed as necessary. For example, each time the user needs the information relating to the substrate processing apparatus or the system, the user inputs a question into the information processing apparatus 3, and the processing of S21 to S26 is executed. For example, the processing of S21 to S26 is repeated according to an operation by the user.

After S26 ends, the information processing apparatus 3 may perform processing of acquiring a response from the user to the output answer. The response is, for example, information indicating that the user is satisfied with the answer. When the user operates the operation unit provided in the input unit 35, a response from the user is input into the information processing apparatus 3, and the information processing apparatus 3 acquires the response. When the calculator 31 outputs an answer to the question and acquires a response indicating that the user is satisfied with the answer, the calculator 31 may store the question in the database 22 in association with the target data 12 extracted in S23. Thereafter, the question stored in the database 22 is used as one piece of the related data 13 relating to the target data 12. Through this processing, the number of pieces of the related data 13 relating to the target data 12 increases, and the appropriate target data 12 according to the question is more easily extracted.

As described in detail above, the information processing apparatus 3 generates the related data 13 relating to the target data 12, which is a reference target from the user and is generated from the original data 11, and stores the target data 12 and the related data 13 in the database 22 in association with each other. The related data 13 includes a question sentence with respect to the target data 12, a summary of the target data 12, or a question sentence with respect to the summary, and is generated using the language generation model 21. By using the language generation model 21, the related data 13 that reflects the contents of the target data 12 can be easily generated.

The information processing apparatus 3 acquires a question from the user, retrieves the related data 13 from the database 22 based on the question, and extracts the target data 12 associated with the retrieved related data 13. Based on the extracted target data 12, the information processing apparatus 3 uses the language generation model 21 to acquire an answer to the question. The question sentence with respect to the target data 12, the summary of the target data 12, or the question sentence with respect to the summary, which are to be referred to in order to answer the question from the user, may include a content similar to the question from the user. Therefore, by extracting the target data 12 associated with the related data 13 similar to the question from the database 22, the target data 12 to be referred to in order to answer the question may be selected. Since the language generation model 21 is used to obtain an answer based on the target data 12 to be referred to in order to answer the question, an appropriate answer can be obtained according to the question.

Since an appropriate answer can be obtained with respect to the question from the user, the user can obtain necessary information by inputting a question relating to the substrate processing apparatus or the system to obtain an answer. For example, when it is desired to acquire, from the original data 11 illustrated in FIG. 4, the information on the method of cleaning the piping, in a retrieval method using a keyword in the related art, there is a possibility that information on the method of cleaning units other than the piping is retrieved. In the embodiment, in response to a question relating to the method of cleaning the piping, the target data 12 relating to the method of cleaning the piping is extracted from the plurality of pieces of target data 12, and an answer relating to the method of cleaning the piping is obtained based on the extracted target data 12. Accordingly, the user can easily obtain desired information on the substrate processing apparatus or the system.

In the embodiment, the example, in which the original data 11 and the target data 12 are data that include information on the substrate processing apparatus or on the system relating to the substrate processing apparatus, has been mainly described. Alternatively, the original data 11 and the target data 12 may be data that include information on an apparatus other than the substrate processing apparatus or a system relating to the apparatus, such as a machine tool. In the embodiment, an example in which the same language generation model 21 is used for the processing of S11 to S14 and the processing of S21 to S26 has been described. However, different language generation models may be used for the processing of S11 to S14 and the processing of S21 to S26.

In the embodiment, the processing of S11 to S14 and the processing of S21 to S26 are executed in the same information processing apparatus 3. However, the processing of S11 to S14 and the processing of S21 to S26 may be executed by different information processing apparatuses. For example, one information processing apparatus may execute the processing of S11 to S14 to generate the database 22, and other information processing apparatuses may execute the processing of S21 to S26 using the generated database 22. For example, the information processing apparatus used by an operator providing the information retrieval service may execute the processing of S11 to S14 to generate the database 22, and the information processing apparatus used by the user of the service may execute the processing of S21 to S26 using the database 22.

### Appendix 1

An information processing method, comprising:

inputting, into a language generation model, a request for generating related data including a question sentence with respect to target data relating to a specific apparatus or system, a summary of the target data, or a question sentence with respect to the summary, and acquiring the related data output by the language generation model,

storing, in a database, the target data and the related data in association with each other, acquiring a question relating to the apparatus or the system,

retrieving the related data from the database based on the question,

extracting the target data associated with the retrieved related data from the database,

inputting the question and the extracted target data into the language generation model, and acquiring an answer to the question output by the language generation model, and

outputting the acquired answer.

### Appendix 2

The information processing method according to Appendix 1, further comprising:

acquiring a plurality of pieces of related data relating to a plurality of pieces of target data, and storing, in the database, the respective pieces of target data and the related data relating to the respective pieces of target data in association with each other.

### Appendix 3

The information processing method according to Appendix 1, further comprising:

retrieving related data having a largest similarity to the question when the related data is retrieved.

### Appendix 4

The information processing method according to Appendix 1, further comprising:

retrieving the target data from the database based on the question, and

inputting the question and the retrieved target data into the language generation model, and acquiring an answer to the question output by the language generation model.

### Appendix 5

The information processing method according to Appendix 1, further comprising:

acquiring a response to the outputted answer, and

storing the question in the database in association with the extracted target data when a response indicating that the answer to the question is satisfied is acquired.

### Appendix 6

The information processing method according to Appendix 1, further comprising:

outputting the retrieved related data together with the acquired answer.

### Appendix 7

The information processing method according to Appendix 1, further comprising:

outputting, together with the acquired answer, the extracted target data, a link to the target data, original data from which the target data is generated, or a link to the original data.

### Appendix 8

The information processing method according to Appendix 1, wherein

the target data is data generated from a manual of the apparatus or the system, or is data in a tabular format relating to the apparatus or the system.

### Appendix 9

The information processing method according to Appendix 1, wherein

the apparatus is a substrate processing apparatus, the system includes a device used in association with the substrate processing apparatus, and

the information processing method further comprises outputting, as an answer, information relating to an operation of the apparatus or the system, or information relating to a work with respect to the apparatus or the system.

### Appendix 10

A non-transitory computer-readable storage medium having computer-executable instructions stored thereon, which when executed by a processor, cause the processor to perform a method comprising:

inputting, into a language generation model, a request for generating related data including a question sentence with respect to target data relating to a specific apparatus or system, a summary of the target data, or a question sentence with respect to the summary, and acquiring the related data output by the language generation model,

storing, in a database, the target data and the related data in association with each other,

acquiring a question relating to the apparatus or the system,

retrieving the related data from the database based on the question,

extracting the target data associated with the retrieved related data from the database,

inputting the question and the extracted target data into the language generation model, and acquiring an answer to the question output by the language generation model, and

outputting the acquired answer.

### Appendix 11

The non-transitory computer-readable storage medium according to Appendix 10, wherein the method further comprises:

acquiring a plurality of pieces of related data relating to a plurality of pieces of target data, and storing, in the database, the respective pieces of target data and the related data relating to the respective pieces of target data in association with each other.

### Appendix 12

The non-transitory computer-readable storage medium according to Appendix 10, wherein the method further comprises:

retrieving related data having a largest similarity to the question when the related data is retrieved.

### Appendix 13

The non-transitory computer-readable storage medium according to Appendix 10, wherein the method further comprises:

retrieving the target data from the database based on the question, and

inputting the question and the retrieved target data into the language generation model, and acquiring an answer to the question output by the language generation model.

### Appendix 14

The non-transitory computer-readable storage medium according to Appendix 10, wherein the method further comprises:

acquiring a response to the outputted answer, and

storing the question in the database in association with the extracted target data when a response indicating that the answer to the question is satisfied is acquired.

### Appendix 15

An information processing apparatus comprising:

calculator circuitry configured to: input, into a language generation model, a request for generating related data including a question sentence with respect to target data relating to a specific apparatus or system, a summary of the target data, or a question sentence with respect to the summary, and acquire the related data output by the language generation model,

store, in a database, the target data and the related data in association with each other,

acquire a question relating to the apparatus or the system,

retrieve the related data from the database based on the question,

extract the target data associated with the retrieved related data from the database,

input the question and the extracted target data into the language generation model, and acquire an answer to the question output by the language generation model, and

output the acquired answer.

### Appendix 16

The information processing apparatus according to Appendix 15, wherein the calculator circuitry is further configured to:

acquire a plurality of pieces of related data relating to a plurality of pieces of target data, and store, in the database, the respective pieces of target data and the related data relating to the respective pieces of target data in association with each other.

### Appendix 17

The information processing apparatus according to Appendix 15, wherein the calculator circuitry is further configured to:

retrieve related data having a largest similarity to the question when the related data is retrieved.

### Appendix 18

The information processing apparatus according to Appendix 15, wherein the calculator circuitry is further configured to:

retrieve the target data from the database based on the question, and

input the question and the retrieved target data into the language generation model, and acquiring an answer to the question output by the language generation model.

### Appendix 19

The information processing apparatus according to Appendix 15, wherein the calculator circuitry is further configured to:

acquire a response to the outputted answer, and

store the question in the database in association with the extracted target data when a response indicating that the answer to the question is satisfied is acquired.

### Appendix 20

The information processing apparatus according to Appendix 15, wherein the calculator circuitry is further configured to:

output the retrieved related data together with the acquired answer.

The invention is not limited to contents of the above-described embodiment, and various modifications may be made within the scope described in the following claims. In other words, embodiments obtained by combining technical means appropriately changed within the scope indicated in the claims are also included in the technical scope of the invention.

The features described in each embodiment can be combined with each other. In addition, the independent and dependent claims set forth in the claims can be combined with each other in any and all combinations, regardless of the reciting format. Further, the claims use a format of describing claims that recite two or more other claims (multi-claim format). However, the disclosure is not limited thereto. The claims may also be described using a format of multi-claims reciting at least one multi-claim format or multi-claim (multi-multi claims).

1. An information processing method, comprising:
inputting, into a language generation model, a request for generating related data including a question sentence with respect to target data relating to a specific apparatus or system, a summary of the target data, or a question sentence with respect to the summary, and acquiring the related data output by the language generation model,
storing, in a database, the target data and the related data in association with each other,
acquiring a question relating to the apparatus or the system,
retrieving the related data from the database based on the question,
extracting the target data associated with the retrieved related data from the database,
inputting the question and the extracted target data into the language generation model, and acquiring an answer to the question output by the language generation model, and
outputting the acquired answer.

2. The information processing method according to claim 1, further comprising:
acquiring a plurality of pieces of related data relating to a plurality of pieces of target data, and
storing, in the database, the respective pieces of target data and the related data relating to the respective pieces of target data in association with each other.

3. The information processing method according to claim 1, further comprising:
retrieving related data having a largest similarity to the question when the related data is retrieved.

4. The information processing method according to claim 1, further comprising:
retrieving the target data from the database based on the question, and
inputting the question and the retrieved target data into the language generation model, and acquiring an answer to the question output by the language generation model.

5. The information processing method according to claim 1, further comprising:
acquiring a response to the outputted answer, and
storing the question in the database in association with the extracted target data when a response indicating that the answer to the question is satisfied is acquired.

6. The information processing method according to claim 1, further comprising:
outputting the retrieved related data together with the acquired answer.

7. The information processing method according to claim 1, further comprising:
outputting, together with the acquired answer, the extracted target data, a link to the target data, original data from which the target data is generated, or a link to the original data.

8. The information processing method according to claim 1, wherein
the target data is data generated from a manual of the apparatus or the system, or is data in a tabular format relating to the apparatus or the system.

9. The information processing method according to claim 1, wherein
the apparatus is a substrate processing apparatus, the system includes a device used in association with the substrate processing apparatus, and
the information processing method further comprises outputting, as an answer, information relating to an operation of the apparatus or the system, or information relating to a work with respect to the apparatus or the system.

10. A non-transitory computer-readable storage medium having computer-executable instructions stored thereon, which when executed by a processor, cause the processor to perform a method comprising:
inputting, into a language generation model, a request for generating related data including a question sentence with respect to target data relating to a specific apparatus or system, a summary of the target data, or a question sentence with respect to the summary, and acquiring the related data output by the language generation model,
storing, in a database, the target data and the related data in association with each other,
acquiring a question relating to the apparatus or the system,
retrieving the related data from the database based on the question,
extracting the target data associated with the retrieved related data from the database,
inputting the question and the extracted target data into the language generation model, and acquiring an answer to the question output by the language generation model, and
outputting the acquired answer.

11. The non-transitory computer-readable storage medium according to claim 10, wherein the method further comprises:
acquiring a plurality of pieces of related data relating to a plurality of pieces of target data, and
storing, in the database, the respective pieces of target data and the related data relating to the respective pieces of target data in association with each other.

12. The non-transitory computer-readable storage medium according to claim 10, wherein the method further comprises:
retrieving related data having a largest similarity to the question when the related data is retrieved.

13. The non-transitory computer-readable storage medium according to claim 10, wherein the method further comprises:
retrieving the target data from the database based on the question, and
inputting the question and the retrieved target data into the language generation model, and acquiring an answer to the question output by the language generation model.

14. The non-transitory computer-readable storage medium according to claim 10, wherein the method further comprises:
acquiring a response to the outputted answer, and
storing the question in the database in association with the extracted target data when a response indicating that the answer to the question is satisfied is acquired.

15. An information processing apparatus comprising:
calculator circuitry configured to:
input, into a language generation model, a request for generating related data including a question sentence with respect to target data relating to a specific apparatus or system, a summary of the target data, or a question sentence with respect to the summary, and acquire the related data output by the language generation model,
store, in a database, the target data and the related data in association with each other,
acquire a question relating to the apparatus or the system,
retrieve the related data from the database based on the question,
extract the target data associated with the retrieved related data from the database,
input the question and the extracted target data into the language generation model, and acquire an answer to the question output by the language generation model, and
output the acquired answer.

16. The information processing apparatus according to claim 15, wherein the calculator circuitry is further configured to:
acquire a plurality of pieces of related data relating to a plurality of pieces of target data, and
store, in the database, the respective pieces of target data and the related data relating to the respective pieces of target data in association with each other.

17. The information processing apparatus according to claim 15, wherein the calculator circuitry is further configured to:
retrieve related data having a largest similarity to the question when the related data is retrieved.

18. The information processing apparatus according to claim 15, wherein the calculator circuitry is further configured to:
retrieve the target data from the database based on the question, and
input the question and the retrieved target data into the language generation model, and acquiring an answer to the question output by the language generation model.

19. The information processing apparatus according to claim 15, wherein the calculator circuitry is further configured to:
acquire a response to the outputted answer, and
store the question in the database in association with the extracted target data when a response indicating that the answer to the question is satisfied is acquired.

20. The information processing apparatus according to claim 15, wherein the calculator circuitry is further configured to:
output the retrieved related data together with the acquired answer.
